(19) United States
(12) Patent Application Publication
(10) Pub. No.: US 2022/0158306 A1
(43) Pub. Date: May 19, 2022

(54) POWER STORAGE DEVICE

(71) Applicant: Panasonic Intellectual Property Management Co., Ltd., Osaka (JP)

(72) Inventors: AKIHIRO YONEYAMA, Hyogo (JP); MITSUTOSHI TAJIMA, Hyogo (JP); SHOTA NORIMINE, Osaka (JP)

(21) Appl. No.: 17/441,235

(22) PCT Filed: Mar. 17, 2020
(86) PCT No.: PCT/JP2020/011719

§ 371 Date: Sep. 20, 2021

(30) Foreign Application Priority Data
Mar. 27, 2019 (JP) 2019-060320

(51) Int. Cl. H01M 50/474; H01M 50/55; H01M 50/477

(52) U.S. Cl. CPC H01M 50/474; H01M 50/477; H01M 50/55

(57) ABSTRACT

A power storage device includes: a housing having a terminal arrangement part; a pair of output terminals provided in the terminal arrangement part; an electrode assembly housed in the housing; a pair of current collecting parts that electrically connect the electrode assembly and the pair of output terminals; and an insulating electrode assembly holder that has contact with a pair of first surfaces of the electrode assembly facing each other in first direction X in which the pair of current collecting parts are arranged, is fixed to the housing, and sandwiches the electrode assembly in first direction X.

### TECHNICAL FIELD

The present disclosure relates to a power storage device.

### BACKGROUND ART

For example, as a power source requiring a high output voltage for a vehicle or the like, a power storage module having an assembly in which a plurality of power storage devices (for example, batteries) are connected in series is known. A power storage device used in such a power storage module generally includes an outer can having an opening, an electrode assembly housed in the outer can, a sealing plate that closes the opening of the outer can, a pair of output terminals provided on the sealing plate, and a current collecting tab that electrically connects the electrode assembly and the pair of output terminals (see, for example, PTL 1).

### CITATION LIST

### Patent Literature

PTL 1: Unexamined Japanese Patent Publication No. 2011-49064

### SUMMARY OF THE INVENTION

### Technical Problem

In the power storage device, it is common to use the electrode assembly smaller than an internal space of the outer can in consideration of workability when the electrode assembly is housed in the outer can. However, when a dimensional difference is generated between the outer can and the electrode assembly, a space is easily generated between the outer can and the electrode assembly. When a force is applied to the power storage device in a state where there is a space between the outer can and the electrode assembly, the electrode assembly can be easily displaced with respect to the outer can. When the electrode assembly is displaced with respect to the outer can, a force generated by the displacement of the electrode assembly is applied to the current collecting tab, and the current collecting tab is damaged, so that reliability of the power storage device can be deteriorated.

The present disclosure has been made in view of such a situation, and an object of the present disclosure is to provide a technique for improving the reliability of the power storage device.

### Solution to Problem

One aspect of the present disclosure is a power storage device. The power storage device includes: a housing having a terminal arrangement part; a pair of output terminals provided in the terminal arrangement part; an electrode assembly housed in the housing; a pair of current collecting parts that electrically connect the electrode assembly and the pair of output terminals; and an insulating electrode assembly holder that has contact with a pair of first surfaces of the electrode assembly facing each other in a first direction in which the pair of current collecting parts are arranged, is fixed to the housing, and sandwiches the electrode assembly in the first direction.

Any combinations of the above components, and modifications of the expressions of the present disclosure among methods, apparatuses, systems, and the like are also effective as aspects of the present disclosure.

### Advantageous Effect of Invention

According to the present disclosure, the reliability of the power storage device can be enhanced.

### BRIEF DESCRIPTION OF DRAWINGS

FIG. 1 is a perspective view of a power storage device according to a first exemplary embodiment.

FIG. 2 is a cross-sectional view of a region including a pair of output terminals in the power storage device.

FIG. 3(A) is a perspective view of one holder unit as viewed obliquely from above, and FIG. 3(B) is a perspective view of one holder unit as viewed obliquely from below.

FIG. 4 is a cross-sectional view of a region including one holder unit in the power storage device.

FIG. 5(A) is a perspective view of the other holder unit as viewed obliquely from above, and FIG. 5(B) is a perspective view of the other holder unit as viewed obliquely from below.

FIG. 6 is a perspective view of a power storage device according to a second exemplary embodiment.

FIG. 7 is a side view of the power storage device.

FIG. 8 is an enlarged perspective view illustrating a region including a cutout part of the electrode assembly holder.

FIG. 9(A) is a perspective view of a power storage device according to a first modification. FIG. 9(B) is a perspective view of a second electrode assembly holder.

### DESCRIPTION OF EMBODIMENTS

Hereinafter, a power storage device of the present disclosure will be described based on preferred exemplary embodiments with reference to the drawings. The exemplary embodiments are not intended to limit the invention but are an example, and all features described in the exemplary embodiments and combinations thereof are not necessarily essential to the invention. The same or equivalent components, members, and processing illustrated in the drawings are denoted by the same reference numerals, and redundant description will be omitted as appropriate. Further, the scale and shape of each part illustrated in each drawing are set for convenience in order to facilitate the description, and are not limitedly interpreted unless otherwise specified. In addition, when terms “first”, “second”, and the like are used in the present specification or claims, unless otherwise specified, these terms do not represent any order or importance, and are intended to distinguish one configuration from another configuration. Furthermore, in each drawing, some of members that are not important for describing the exemplary embodiment are omitted.

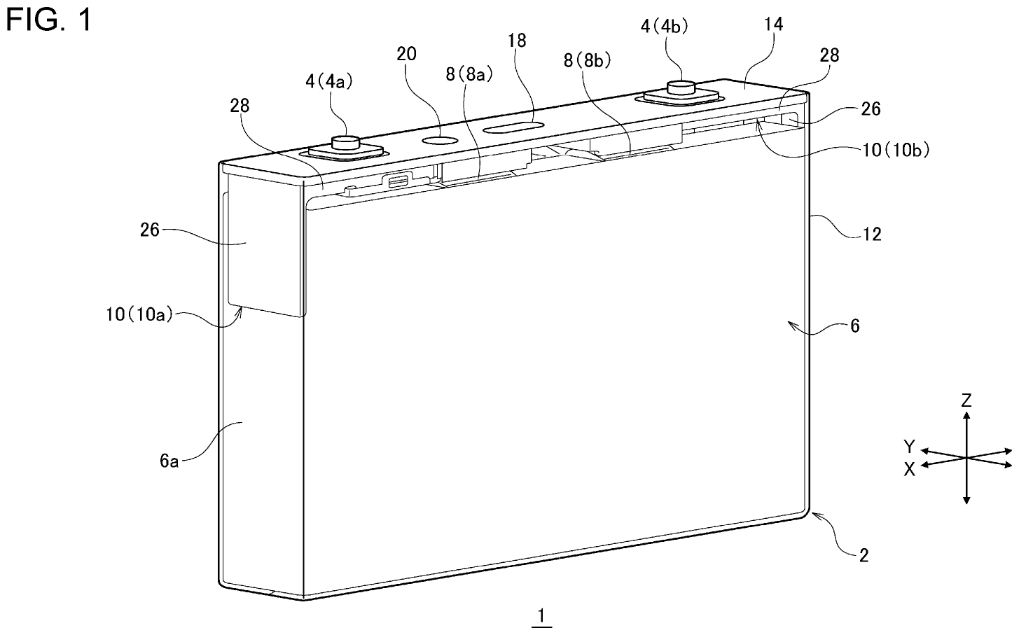

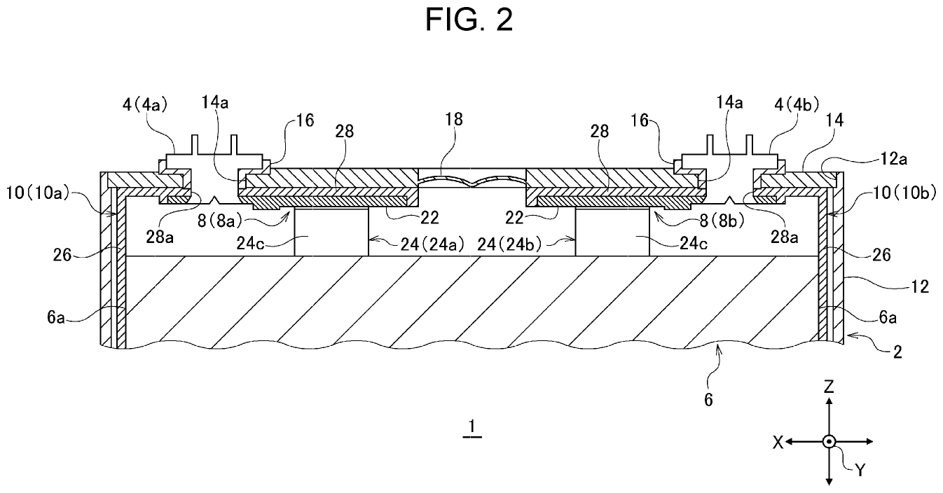

FIG. 1 is a perspective view of power storage device 1 according to a first exemplary embodiment. FIG. 2 is a cross-sectional view of a region including a pair of output terminals in power storage device 1. FIG. 1 shows the inside of power storage device 1 in a see-through manner. In FIGS. 1 and 2, electrode assembly 6 is schematically shown.

Power storage device 1 is, for example, a rechargeable secondary battery such as a lithium ion battery, a nickel-hydrogen battery, or a nickel-cadmium battery, or a capacitor. Power storage device 1 is a so-called prismatic battery. Power storage device 1 includes housing 2, a pair of output terminals 4, electrode assembly 6, a pair of current collecting parts 8, and electrode assembly holder 10.

Housing 2 has a flat rectangular parallelepiped shape, and includes outer can 12 and sealing plate 14. Outer can 12 has, for example, opening 12a having a rectangular and bottomed cylindrical shape. Electrode assembly 6, an electrolytic solution, and the like are accommodated in outer can 12 through opening 12a. Sealing plate 14 is a rectangular plate, and seals outer can 12 by closing opening 12a. Outer can 12 and sealing plate 14 are conductors, and are made of metal such as aluminum, iron, or stainless steel, for example. Opening 12a of outer can 12 and a peripheral edge of sealing plate 14 are joined to each other by, for example, laser welding.

Sealing plate 14 is provided with a pair of output terminals 4. Therefore, sealing plate 14 constitutes a terminal arrangement part. Specifically, output terminal 4 of a positive electrode is provided near one end in a longer direction of sealing plate 14, and output terminal 4 of a negative electrode is provided near the other end. Hereinafter, output terminal 4 of the positive electrode is appropriately referred to as positive electrode terminal 4a, and output terminal 4 of the negative electrode is appropriately referred to as negative electrode terminal 4b. When it is not necessary to distinguish polarities of output terminals 4, positive electrode terminal 4a and negative electrode terminal 4b are collectively referred to as output terminals 4. The pair of output terminals 4 are inserted, respectively, into through holes 14a formed in sealing plate 14. Insulating seal members 16 are interposed between the pair of output terminals 4 and each of through holes 14a.

Sealing plate 14 is provided with safety valve 18 between the pair of output terminals 4. Safety valve 18 may not be provided. Safety valve 18 is configured to open when an internal pressure of housing 2 rises to a predetermined value or more to release a gas inside housing 2. Safety valve 18 includes, for example, a thin portion having a thickness smaller than a thickness of the other portion provided in a part of sealing plate 14, and a linear groove formed on a surface of the thin portion. In this configuration, when the internal pressure of housing 2 increases, the thin portion is torn starting from the groove to open the valve. Safety valve 18 is not limited to the irreversible valve described above, and may be a self-restoring exhaust valve that seals again when the pressure in housing 2 becomes equal to or less than a certain value after valve opening.

Sealing plate 14 is provided with liquid filling hole 20 between the pair of output terminals 4. Liquid filling hole 20 is used when an electrolyte solution is filled in housing 2. In one example of an assembling process of power storage device 1, after electrode assembly 6 is housed in outer can 12, outer can 12 and sealing plate 14 are laser-welded to each other. Thereafter, an electrolyte solution is injected into housing 2 through liquid filling hole 20. Further, after the electrolyte solution is injected, a liquid filling plug (not shown) is joined to liquid filling hole 20 by laser welding or the like. In addition, liquid filling hole 20 may be sealed by swaging a rivet plug into liquid filling hole 20, or may be sealed by press-fitting a liquid filling plug made of an elastic material into liquid filling hole 20.

In the description of the present exemplary embodiment, for the sake of convenience, a surface where sealing plate 14 (the terminal arrangement part) is provided is defined as an upper surface of power storage device 1, and an opposite surface is defined as a bottom surface of power storage device 1. Further, power storage device 1 has four side surfaces which connect the upper surface and the bottom surface. Two of the four side surfaces are a pair of long side surfaces connected to long sides of the upper surface and the bottom surface. The long side surfaces are surfaces having the largest area among six surfaces of power storage device 1, that is, main surfaces. The remaining two side surfaces excluding the two long side surfaces are a pair of short side surfaces connected to short sides of the upper surface and the bottom surface of power storage device 1. These directions and positions are defined for convenience. Therefore, for example, a part defined as the upper surface in the present disclosure does not mean that it is always located above the part defined as the bottom surface.

Further, a direction in which a pair of current collecting tabs 24 to be described later are arranged (or a width direction of a main surface of current collecting tabs 24) is defined as first direction X, a direction in which a pair of long side surfaces are arranged (or a stacking direction of a plurality of electrode plates constituting electrode assembly 6) is defined as second direction Y, and a direction in which the upper surface and the bottom surface are arranged is defined as third direction Z. In addition, in the present disclosure, the direction in which current collecting tabs 24 are arranged may be a direction in which current collecting tabs 24 are arranged when electrode assembly 6 is viewed in the second direction. That is, it does not necessarily mean a direction in which an imaginary straight line connecting current collecting tabs 24 extends.

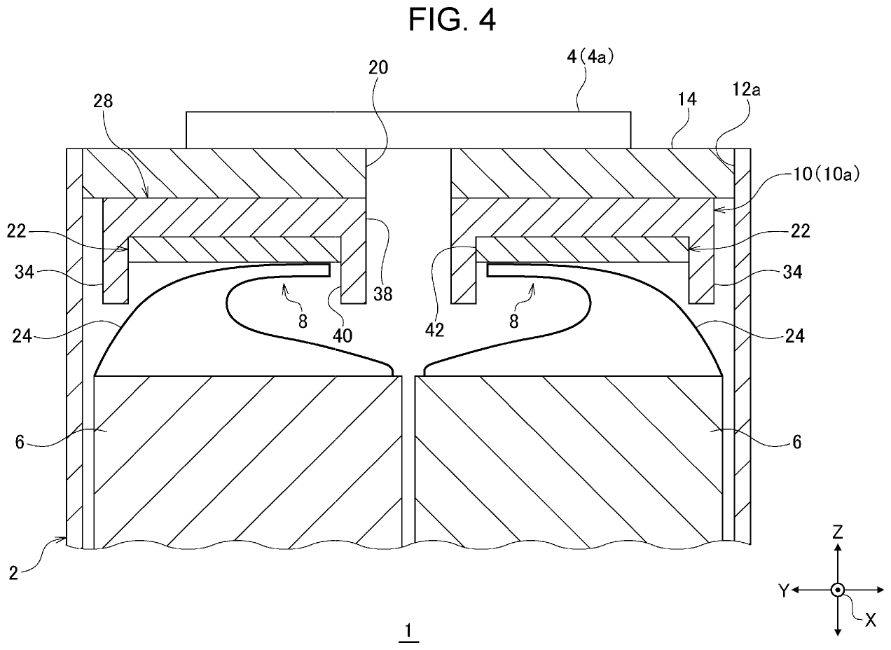

Housing 2 houses electrode assembly 6, the pair of current collecting parts 8, and electrode assembly holder 10. Electrode assembly 6 is an electrode group having a structure in which a plurality of electrode plates are stacked. Specifically, electrode assembly 6 has a structure in which a positive electrode plate that is an electrode plate of a positive electrode and a negative electrode plate that is an electrode plate of a negative electrode are alternately stacked. An electrode plate separator is interposed between the positive electrode plate and the negative electrode plate, which are adjacent to each other. In the present exemplary embodiment, two electrode assemblies 6 are arranged in second direction Y and housed in housing 2 (see FIG. 4).

As an example, the positive electrode plate includes a positive electrode current collecting assembly made of a metal foil, and a positive electrode active material layer (positive electrode mixture layer) containing a positive electrode active material stacked on a surface of the positive electrode current collecting assembly. The negative electrode plate includes a negative electrode current collecting assembly made of a metal foil, and a negative electrode active material layer (negative electrode mixture layer) containing a negative electrode active material stacked on a surface of the negative electrode current collecting assembly. Each of the positive electrode current collecting assembly and the negative electrode current collecting assembly has an electrode part on which the mixture layer of each electrode is stacked, and a tab part extending from an edge of the electrode part and constituting current collecting tabs 24 described later.

Each of electrode assemblies 6 has a shape substantially similar to that of housing 2. Accordingly, each of electrode assemblies 6 has an upper surface facing sealing plate 14 of housing 2, a bottom surface facing a bottom surface of housing 2, a pair of long side surfaces facing a pair of long side surfaces of housing 2, and a pair of short side surfaces facing a pair of short side surfaces of housing 2. A predetermined gap is provided between each surface of housing 2 and each surface of electrode assemblies 6.

Electrode assemblies 6 and the pair of output terminals 4 are electrically connected by the pair of current collecting parts 8. Current collecting parts 8 include positive electrode current collecting part 8a electrically connected to positive electrode terminal 4a, and negative electrode current collecting part 8b electrically connected to negative electrode terminal 4b. Hereinafter, when it is not necessary to distinguish the polarities of current collecting parts 8, positive electrode current collecting part 8a and negative electrode current collecting part 8b are collectively referred to as current collecting parts 8.

Each of current collecting parts 8 includes current collecting plate 22 and current collecting tab 24. Current collecting plate 22 is fixed to sealing plate 14 (the terminal arrangement part). Specifically, each current collector plate 22 is disposed on a surface of sealing plate 14 facing an inside of housing 2 via second plate part 28 described later of electrode assembly holder 10, and fixed to sealing plate 14 by each of output terminals 4. In this state, each current collector plate 22 is electrically connected to an end portion of each of output terminals 4 located in housing 2.

Current collecting tabs 24 are belt-like (tongue-shaped) parts that connect electrode assemblies 6 and current collecting plates 22 to each other. Current collecting tabs 24 extend from electrode plates of electrode assemblies 6 and are connected to current collecting plates 22. Current collecting tabs 24 include positive electrode tab 24a extending from the positive electrode plate, and negative electrode tab 24b extending from the negative electrode plate. Positive electrode tab 24a extending from the positive electrode plate is connected to current collecting plate 22 fixed to positive electrode terminal 4a. Negative electrode tab 24b extending from the negative electrode plate is connected to current collecting plate 22 fixed to negative electrode terminal 4b. Hereinafter, when it is not necessary to distinguish the polarities of current collecting tabs 24, positive electrode tab 24a and negative electrode tab 24b are collectively referred to as current collecting tabs 24. Current collecting tabs 24 of the same polarity are bundled to form a current collecting tab stacked body. The stacked body is joined to current collecting plate 22 by ultrasonic welding, laser welding, or the like.

In addition, each of current collecting plate 22 on a positive electrode and current collecting plate 22 on a negative electrode may be made of a single plate material, or may be made of a combination of a plurality of plate materials. When current collecting plate 22 is formed of a plurality of plate members, the plurality of plate members can be divided into a plate member to which current collecting tabs 24 are joined and a plate member connected to output terminals 4. Thus, a step of joining current collecting tabs 24 to current collecting plate 22 and a step of joining output terminals 4 and current collecting plate 22 can be performed in parallel. As an example, the plate members are joined after both the steps are completed.

Each of current collecting tabs 24 is disposed such that main surface 24c faces second direction Y that intersects with first direction X in which the pair of current collecting parts 8 are arranged. That is, an end portion of each current collecting tab 24 close to electrode assembly 6 extends in first direction X. An end portion close to current collecting plate 22 also extends in first direction X. Current collecting tabs 24 extend toward current collecting plates 22 while being curved in second direction Y, and are connected to current collecting plates 22. Accordingly, main surface 24c of each current collecting tab 24 faces sealing plate 14 in second direction Y in a partial region, and faces third direction Z in the other partial region. Each current collecting tab 24 may not be formed of tab parts of the positive electrode current collecting assembly and the negative electrode current collecting assembly. For example, each current collecting tab 24 may be formed of a conductive member separate from the positive electrode current collecting assembly and the negative electrode current collecting assembly, and the conductive member may be joined to each of the positive electrode current collecting assembly and the negative electrode current collecting assembly.

Displacement of electrode assembly 6 in housing 2 is regulated by electrode assembly holder 10. Electrode assembly holder 10 is brought into contact with a pair of first surfaces 6a of electrode assembly 6 that face each other in first direction X where the pair of current collecting parts 8 are arranged. The pair of first surfaces 6a of electrode assembly 6 are a pair of short side surfaces extending in a direction intersecting with the terminal arrangement part. Electrode assembly holder 10 is fixed to housing 2 to sandwich electrode assembly 6 in first direction X. This suppresses displacement of electrode assembly 6 in first direction X. Further, since electrode assembly 6 is sandwiched by electrode assembly holder 10 in first direction X, the displacement of electrode assembly 6 in second direction Y and the displacement of electrode assembly 6 in third direction Z are suppressed to a considerable extent.

Electrode assembly holder 10 has an insulating property. For example, electrode assembly holder 10 is made of a thermoplastic resin having an insulating property such as polypropylene (PP), polybutylene terephthalate (PBT), polycarbonate (PC), and Noryl (registered trademark) resin (modified PPE). Electrode assembly holder 10 preferably has higher rigidity than current collecting tabs 24.

Electrode assembly holder 10 of the present exemplary embodiment includes a pair of first plate parts 26 and second plate part 28. The pair of first plate parts 26 extend in third direction Z and have contact with the pair of first surfaces 6a. Specifically, a predetermined gap is provided between the pair of first surfaces 6a of electrode assembly 6 and the pair of short side surfaces of housing 2. One of first plate parts 26 is interposed between first surface 6a close to positive electrode terminal 4a and the short side surface of housing 2 facing first surface 6a, and has contact with first surface 6a. The other of first plate parts 26 is interposed between first surface 6a close to negative electrode terminal 4b and the short side surface of housing 2 facing first surface 6a, and has contact with first surface 6a. Each of first plate parts 26 of the present exemplary embodiment is separated from each short side surface of housing 2. Accordingly, contact between electrode assembly 6 and housing 2 can be more reliably suppressed.

Second plate part 28 is formed integrally with each first plate part 26. First plate parts 26 and second plate part 28 of the present exemplary embodiment are integrally molded products of resin. Second plate part 28 is interposed between sealing plate 14 (the terminal arrangement part) and electrode assembly 6 and fixed to sealing plate 14. Second plate part 28 has through holes 28a at positions overlapping output terminals 4 when viewed in third direction Z. Ends of output terminals 4 located in housing 2 are inserted into through holes 28a. Therefore, second plate part 28 is fixed to sealing plate 14 by each output terminal 4. Further, second plate part 28 is interposed between sealing plate 14 (the terminal arrangement part) and current collecting plate 22 to electrically insulate the sealing plate and the current collecting plate from each other. That is, second plate part 28 also functions as an insulating member that electrically insulates sealing plate 14 from current collecting plate 22.

Second plate part 28 is divided into a part to which one of first plate parts 26 is connected to positive electrode terminal 4a and a part to which the other of first plate parts 26 is connected to negative electrode terminal 4b. That is, electrode assembly holder 10 of the present exemplary embodiment includes a pair of holder units 10a, 10b arranged in first direction X. Each of the pair of holder units 10a, 10b includes first plate part 26 and second plate part 28. One holder unit 10a has contact with one first surface 6a of electrode assembly 6 and is fixed to housing 2. Another holder unit 10b has contact with another first surface 6a of electrode assembly 6 and is fixed to housing 2.

More specifically, first plate part 26 of one holder unit 10a is brought into contact with one first surface 6a positioned close to positive electrode terminal 4a. Second plate part 28 of one holder unit 10a is fixed to sealing plate 14 by positive electrode terminal 4a. That is, in a state where second plate part 28 is sandwiched between sealing plate 14 and current collecting plate 22, positive electrode terminal 4a is inserted into second plate part 28 and current collecting plate 22. The end portion of positive electrode terminal 4a close to the electrode assembly is swaged, whereby second plate part 28 and current collecting plate 22 are fixed to sealing plate 14. Current collecting plate 22 and sealing plate 14 are insulated from each other by second plate part 28 interposed therebetween.

First plate part 26 of other holder unit 10b has contact with other first surface 6a positioned close to negative electrode terminal 4b. Second plate part 28 of other holder unit 10b is fixed to sealing plate 14 by negative electrode terminal 4b. That is, in a state where second plate part 28 is sandwiched between sealing plate 14 and current collecting plate 22, negative electrode terminal 4b is inserted into second plate part 28 and current collecting plate 22. The end portion of negative electrode terminal 4b close to the electrode assembly is swaged, whereby second plate part 28 and current collecting plate 22 are fixed to sealing plate 14. Current collecting plate 22 and sealing plate 14 are insulated from each other by second plate part 28 interposed therebetween. Accordingly, the pair of first surfaces 6a of electrode assembly 6 are sandwiched between holder unit 10a and holder unit 10b in first direction X.

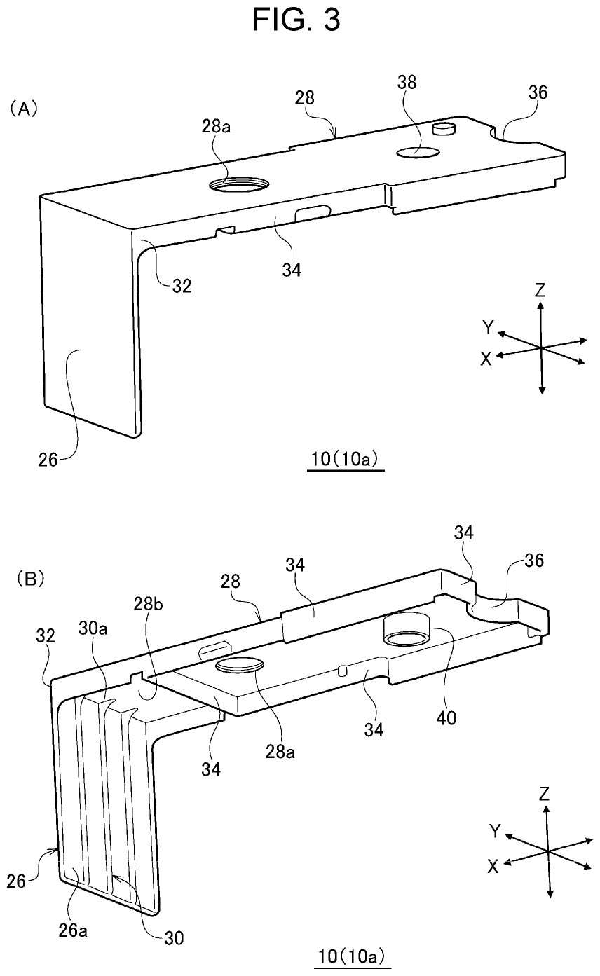

FIG. 3(A) is a perspective view of one holder unit 10a as viewed obliquely from above, and FIG. 3(B) is a perspective view of one holder unit 10a as viewed obliquely from below. In holder unit 10a, first plate part 26 and second plate part 28 are connected at a right angle, and have an L shape when viewed in second direction Y.

First plate part 26 has reinforcing ribs 30 on surface 26a facing electrode assembly 6. First plate part 26 of the present exemplary embodiment has, for example, three reinforcing ribs 30. Three reinforcing ribs 30 are arranged at predetermined intervals in second direction Y, and each extends in third direction Z from a lower end to an upper end of first plate part 26. Projecting portion 30a extending along surface 28b of second plate part 28 facing electrode assembly 6 is formed on an upper end portion of each of reinforcing ribs 30. That is, projecting portion 30a of reinforcing ribs 30 constitutes a triangular rib fixed to surface 26a of first plate part 26 facing electrode assembly 6 and surface 28b of second plate part 28 facing electrode assembly 6 at connecting part 32 between first plate part 26 and second plate part 28. Providing reinforcing ribs 30 can increase the rigidity of holder unit 10a. This makes it possible to more reliably suppress displacement of electrode assembly 6 in first direction X. A number of reinforcing ribs 30 may not be three, and may be one or more. Reinforcing ribs 30 may extend from a region facing connecting part 32 in first wall part 34. In the shape of projecting portion 30a, an oblique side part of the above-described triangular rib may be curved.

Second plate part 28 has a plurality of first wall parts 34 protruding toward electrode assembly 6. Second plate part 28 of the present exemplary embodiment has four first wall parts 34. Two first wall parts 34 are provided on two sides of second plate part 28 extending in first direction X. One first wall part 34 is provided on one side extending in second direction Y at an end portion of second plate part 28 opposite to connecting part 32. Remaining one first wall part 34 is provided in a region between connecting part 32 and through hole 28a on surface 28b facing electrode assembly 6. Therefore, two first wall parts 34 extend in first direction X, and two first wall parts 34 extend in second direction Y. The end portions of four first wall parts 34 are continuous, and form a rectangular frame when viewed in third direction Z. Four first wall parts 34 surround the periphery of current collecting plate 22 in a state where holder unit 10a and current collecting plate 22 are fixed to sealing plate 14. By providing first wall parts 34, contact between current collecting plate 22 and outer can 12 or sealing plate 14 can be more reliably suppressed. In addition, second plate part 28 of holder unit 10a may have a protrusion on its upper surface. Further, sealing plate 14 may have a recessed part at a position corresponding to the protrusion. By fitting the protrusion and the recessed part, holder unit 10a is prevented from rotating about positive electrode terminal 4a. Therefore, it is easy to align holder unit 10a with sealing plate 14 and holder unit 10b.

Second plate part 28 has recessed part 36 that is curved toward an outside of power storage device 1 in first direction X at an end portion opposite to connecting part 32. Recessed part 36 is disposed so as to overlap the edge of safety valve 18 when viewed in third direction Z. That is, by providing recessed part 36, it is possible to prevent a part of safety valve 18 from being blocked by holder unit 10a.

Second plate part 28 has through hole 38 at a position overlapping liquid filling hole 20 as viewed in third direction Z. By providing through hole 38, it is possible to avoid liquid filling hole 20 from being blocked by holder unit 10a. Further, second plate part 28 has second wall part 40 that surrounds an outer periphery of through hole 38 at a peripheral edge portion of through hole 38 in surface 28b facing electrode assembly 6. Second wall part 40 protrudes toward electrode assembly 6 from surface 28b facing electrode assembly 6.

FIG. 4 is a cross-sectional view of a region including one holder unit 10a in power storage device 1. FIG. 4 schematically illustrates electrode assembly 6. Current collecting plate 22 has through hole 42 at a position overlapping liquid filling hole 20 as viewed in third direction Z. By providing through hole 42, it is possible to avoid liquid filling hole 20 from being blocked by current collecting plate 22. Further, second wall part 40 is inserted into through hole 42 while holder unit 10a and current collecting plate 22 are fixed to sealing plate 14. Second wall part 40 protrudes toward electrode assembly 6 from current collecting plate 22 in third direction Z. Second wall part 40 suppresses displacement of current collecting tab 24 in a region overlapping liquid filling hole 20 as viewed in third direction Z. As a result, liquid filling hole 20 can be prevented from being blocked by current collecting tab 24.

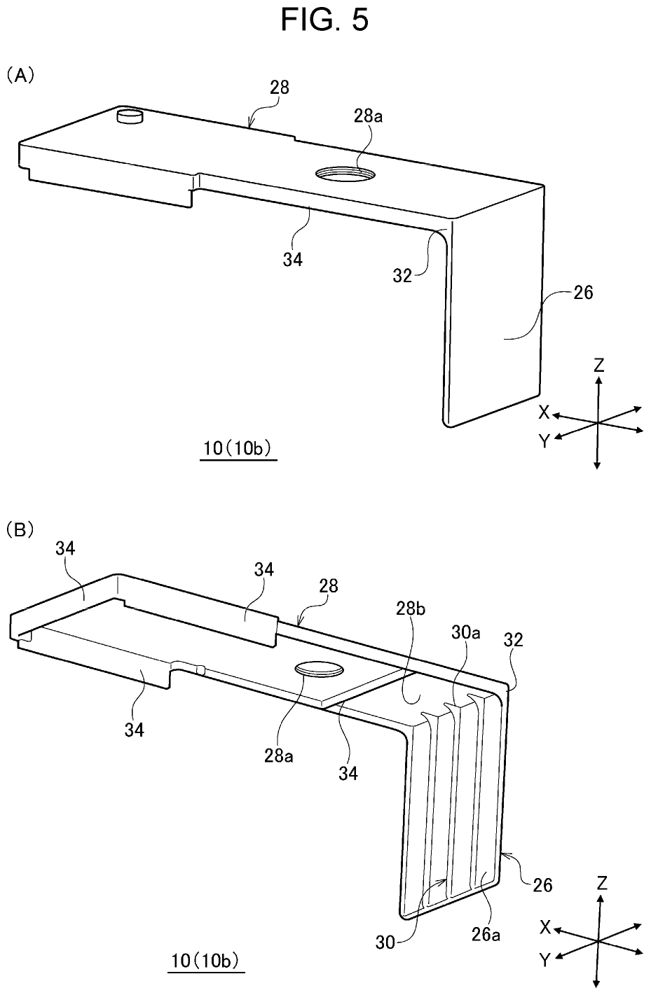

FIG. 5(A) is a perspective view of other holder unit 10b as viewed obliquely from above, and FIG. 5(B) is a perspective view of other holder unit 10b as viewed obliquely from below. In holder unit 10b, first plate part 26 and second plate part 28 are connected at a right angle, and have an L shape when viewed in second direction Y. Similarly to holder unit 10a, first plate part 26 has reinforcing ribs 30 on surface 26a facing electrode assembly 6. The upper end portions of reinforcing ribs 30 are provided with projecting portions 30a extending along surface 28b of second plate part 28 facing electrode assembly 6. Providing reinforcing ribs 30 can increase the rigidity of holder unit 10b. This makes it possible to more reliably suppress displacement of electrode assembly 6 in first direction X. Note that, similarly to holder unit 10a, a number of reinforcing ribs 30 may not be three, and may be one or more. Reinforcing ribs 30 may extend from a region facing connecting part 32 in first wall part 34. In the shape of projecting portion 30a, an oblique side part of the above-described triangular rib may be curved.

Similarly to holder unit 10a, second plate part 28 has a plurality of first wall parts 34 protruding toward electrode assembly 6. Two first wall parts 34 are provided on two sides of second plate part 28 extending in first direction X. One first wall part 34 is provided on one side extending in second direction Y at an end portion of second plate part 28 opposite to connecting part 32. Remaining one first wall part 34 is provided in a region between connecting part 32 and through hole 28a on surface 28b facing electrode assembly 6. The plurality of first wall parts 34 surround the periphery of current collecting plate 22 in a state where holder unit 10b and current collecting plate 22 are fixed to sealing plate 14. By providing first wall parts 34, contact between current collecting plate 22 and outer can 12 or sealing plate 14 can be more reliably suppressed. In addition, similarly to holder unit 10a, second plate part 28 of holder unit 10b may have a protrusion on its upper surface. Further, sealing plate 14 may have a recessed part at a position corresponding to the protrusion. By fitting the protrusion and the recessed part, holder unit 10b is prevented from rotating about negative electrode terminal 4b. Therefore, holder unit 10b is easily aligned with sealing plate 14 and holder unit 10a.

As described above, power storage device 1 according to the present exemplary embodiment includes housing 2 having the terminal arrangement part, the pair of output terminals 4 provided in the terminal arrangement part, electrode assembly 6 accommodated in housing 2, the pair of current collecting parts 8 electrically connecting electrode assembly 6 and the pair of output terminals 4, and insulating electrode assembly holder 10 that has contact with the pair of first surfaces 6a of electrode assembly 6 that face each other in first direction X in which the pair of current collecting parts 8 is arranged, is fixed to housing 2, and sandwiches electrode assembly 6 in first direction X.

As a method of suppressing the expansion of power storage device 1, in other words, the expansion of housing 2, it is conceivable to provide a space that allows the expansion of electrode assembly 6 between housing 2 and electrode assembly 6. By providing a space between housing 2 and electrode assembly 6, at least a part of the expansion of electrode assembly 6 can be absorbed by the space, so that the expansion of power storage device 1 can be suppressed. As a result, an increase in capacity inside the power storage device is suppressed, and a decrease in capacity, an increase in internal resistance, and the like of power storage device 1 can be suppressed. In addition, damage or the like of a joint part between outer can 12 and sealing plate 14 can also be suppressed. Accordingly, the reliability of power storage device 1 can be enhanced. Further, by making electrode assembly 6 smaller than the size of the internal space of housing 2 to form a space between electrode assembly 6 and housing 2, it is possible to reduce resistance such as friction which electrode assembly 6 receives from housing 2 when electrode assembly 6 is housed in housing 2. This improves workability when electrode assembly 6 is housed in housing 2.

However, when a space is provided between housing 2 and electrode assembly 6, electrode assembly 6 is easily displaced with respect to housing 2 when power storage device 1 vibrates. When electrode assembly 6 is displaced with respect to housing 2, stress is concentrated on current collecting tabs 24 connecting electrode assembly 6 and output terminals 4, and there is a possibility that fatigue fracture occurs in current collecting tabs 24. In particular, main surfaces 24c of current collecting tabs 24 face second direction Y or third direction Z intersecting first direction X in which the pair of output terminals 4 are arranged. Therefore, current collecting tabs 24 are less likely to be displaced in first direction X than in other directions. Therefore, when electrode assembly 6 is displaced in first direction X, the fatigue fracture is more easily generated in current collecting tabs 24.

On the other hand, in power storage device 1 of the present exemplary embodiment, electrode assembly 6 is sandwiched in first direction X by electrode assembly holder 10 fixed to housing 2. With such a configuration, it is possible to suppress displacement of electrode assembly 6 with respect to housing 2 when power storage device 1 vibrates or the like. In particular, displacement of electrode assembly 6 in first direction X can be effectively suppressed. Therefore, a load applied to current collecting tabs 24 connecting output terminals 4 and electrode assembly 6 can be reduced. Therefore, a space is provided between housing 2 and electrode assembly 6 to suppress expansion of power storage device 1, and an electrical connection state between electrode assembly 6 and output terminals 4 can be stably maintained. In particular, since both electrode assembly holder 10 and current collecting tabs 24 are fixed to electrode assembly 6 and the terminal arrangement part, a load applied to current collecting tabs 24 can be more reliably reduced by electrode assembly holder 10.

That is, according to the present exemplary embodiment, the reliability of power storage device 1 can be enhanced from both the viewpoints that the expansion of power storage device 1 can be suppressed and the connection state between electrode assembly 6 and output terminal 4 can be stably maintained. In addition, it is possible to increase the capacity of power storage device 1 while maintaining the reliability of power storage device 1.

Further, electrode assembly holder 10 includes: a pair of first plate parts 26 that has contact with the pair of first surfaces 6a of electrode assembly 6; and second plate part 28 that is formed integrally with each of first plate parts 26, is interposed between the terminal arrangement part and electrode assembly 6, and is fixed to the terminal arrangement part. This makes it possible to more reliably suppress displacement of electrode assembly 6 in first direction X.

Current collecting part 8 includes current collecting plate 22 fixed to the terminal arrangement part. Second plate part 28 is interposed between the terminal arrangement part and current collecting plate 22 to electrically insulate the terminal arrangement part and the current collecting plate from each other. That is, electrode assembly holder 10 of the present exemplary embodiment also functions as an insulating member that insulates the terminal arrangement part from current collecting plate 22. Accordingly, it is possible to suppress an increase in a number of components of power storage device 1 due to the provision of electrode assembly holder 10. In addition, it is possible to suppress complication of the structure of power storage device 1. Further, it is possible to suppress complication of the assembling process of power storage device 1.

Electrode assembly holder 10 includes a pair of holder units 10a, 10b. One holder unit 10a has contact with one first surface 6a of electrode assembly 6 and is fixed to housing 2, and other holder unit 10b has contact with other first surface 6a of electrode assembly 6 and is fixed to housing 2. That is, the pair of holder units 10a, 10b are arranged at an interval in first direction X and is fixed to housing 2. This makes it possible to more reliably suppress the displacement of electrode assembly 6 in first direction X.

### Second Exemplary Embodiment

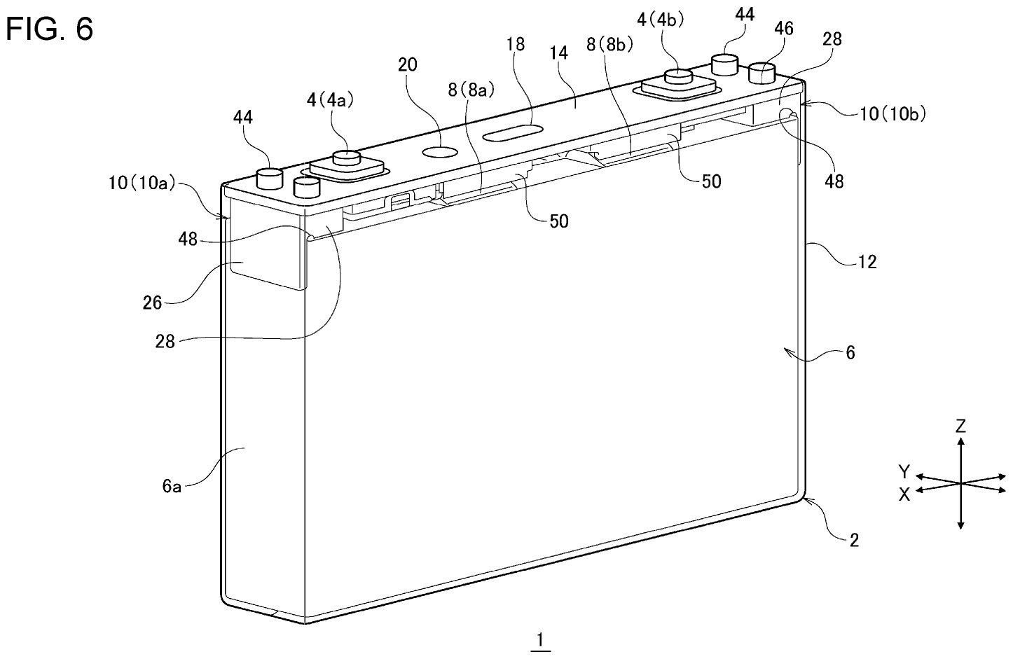

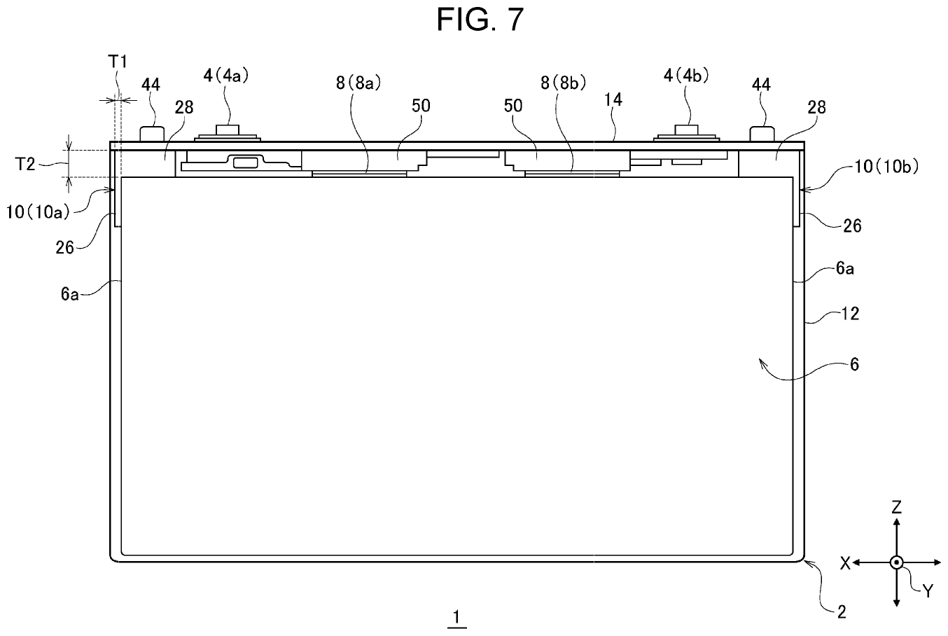

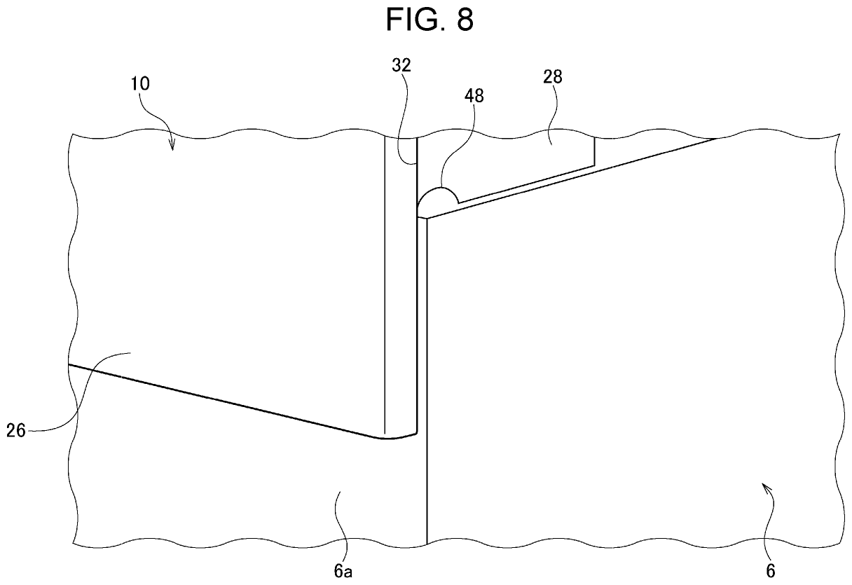

A second exemplary embodiment has the same configuration as the first exemplary embodiment except for the shape of the electrode assembly holder. Hereinafter, the present exemplary embodiment will be described focusing on a configuration different from that of the first exemplary embodiment, and common configurations will be briefly described or description thereof will be omitted. FIG. 6 is a perspective view of a power storage device according to the second exemplary embodiment. FIG. 7 is a side view of the power storage device. FIG. 8 is an enlarged perspective view illustrating a region including a cutout part of the electrode assembly holder. FIGS. 6 and 7 show a state in which the inside of the power storage device is seen through. FIGS. 6 to 8 schematically illustrate an electrode assembly.

Power storage device 1 includes housing 2, a pair of output terminals 4, electrode assembly 6, a pair of current collecting parts 8, and electrode assembly holder 10. Displacement of electrode assembly 6 in housing 2 is regulated by electrode assembly holder 10. Electrode assembly holder 10 is brought into contact with a pair of first surfaces 6a of electrode assembly 6 that face each other in first direction X where the pair of current collecting parts 8 are arranged. Electrode assembly holder 10 is fixed to housing 2 to sandwich electrode assembly 6 in first direction X. This makes it possible to suppress displacement of electrode assembly 6. In particular, displacement of electrode assembly 6 in first direction X can be suppressed.

Electrode assembly holder 10 includes a pair of first plate parts 26 and a pair of second plate parts 28. First plate parts 26 and second plate parts 28 of the present exemplary embodiment are integrally molded products of resin. The pair of first plate parts 26 extend in third direction Z and have contact with the pair of first surfaces 6a. Each of first plate parts 26 is separated from a short side surface of housing 2. Second plate part 28 is formed integrally with each of first plate parts 26, and is interposed between sealing plate 14 (the terminal arrangement part) and electrode assembly 6 to be fixed to sealing plate 14.

Second plate part 28 of the present exemplary embodiment has engagement protrusion part 44 protruding toward sealing plate 14. As an example, two engagement protrusion parts 44 are arranged side by side in second direction Y at both ends of sealing plate 14 in first direction X. In addition, sealing plate 14 has through hole 46 at a position overlapping each engagement protrusion part 44 when viewed in third direction Z. Each engagement protrusion part 44 is inserted into through hole 46. As a result, second plate part 28 is fixed to sealing plate 14. For example, second plate part 28 is press-fitted and fixed to sealing plate 14.

In the present exemplary embodiment, thickness T2 of second plate part 28 is larger than thickness T1 of first plate part 26. Thickness T2 of second plate part 28 is the size of second plate part 28 in third direction Z. Thickness T1 of first plate part 26 is the size of first plate part 26 in first direction X. Thickness T2 is larger than a distance from a lower surface of sealing plate 14 to a lower end of a part of the current collecting tab stacked body joined to current collecting plate 22. As a result, electrode assembly holder 10 can easily suppress the displacement in a direction in which electrode assembly 6 approaches sealing plate 14, in other words, the displacement in third direction Z. Second plate part 28 of the present exemplary embodiment is in contact with sealing plate 14 (the terminal arrangement part) and electrode assembly 6. Accordingly, the displacement of electrode assembly 6 in third direction Z can be more reliably suppressed by electrode assembly holder 10. As a result, the load applied to current collecting tab 24 can be further reduced.

Electrode assembly holder 10 includes a pair of holder units 10a, 10b arranged in first direction X. Each of the pair of holder units 10a, 10b includes first plate part 26 and second plate part 28. In addition, each of second plate parts 28 has engagement protrusion part 44. One holder unit 10a is brought into contact with one first surface 6a of electrode assembly 6 and press-fitted and fixed to sealing plate 14. Another holder unit 10b has contact with another first surface 6a of electrode assembly 6 and is press-fitted and fixed to sealing plate 14. A method of fixing electrode assembly holder 10 to sealing plate 14 is not limited to press-fitting and fixing.

Electrode assembly holder 10 has cutout part 48 in a region facing electrode assembly 6 in connecting part 32 between first plate part 26 and second plate part 28. Cutout part 48 is a recessed part that is provided at an inner corner portion of connecting part 32 between first plate part 26 and second plate part 28 and is curved in a direction away from electrode assembly 6. Therefore, first plate part 26 and second plate part 28 are smoothly connected at connecting part 32. By providing cutout part 48, when first plate part 26 is pushed outward of power storage device 1 by the displacement of electrode assembly 6 in first direction X, it is possible to suppress concentration of stress on the inner corner portion of connecting part 32. Accordingly, breakage of electrode assembly holder 10 can be prevented, and displacement of electrode assembly 6 can be more stably suppressed. In addition, it is possible to suppress concentration of stress on the corner portion of electrode assembly 6. Accordingly, breakage of electrode assembly 6 can be suppressed.

Power storage device 1 of the present exemplary embodiment includes a pair of insulating members 50 that insulate sealing plate 14 from current collecting plate 22 (see FIG. 2). That is, in the present exemplary embodiment, second plate part 28 and insulating members 50 are separate members. Each of insulating members 50 is fixed to sealing plate 14 by each of output terminals 4, and is interposed between current collector plate 22 and sealing plate 14 to electrically insulate them from each other.

Hereinabove, the exemplary embodiments of the power storage device of the present disclosure have been described in detail. The above-described exemplary embodiments are merely specific examples for implementing the power storage device of the present disclosure. The contents of the exemplary embodiments do not limit the technical scope of the power storage device of the present disclosure, and many design changes such as changes, additions, and deletions of components can be made without departing from the spirit of the invention defined in the claims. The new exemplary embodiment to which the design change is made has an effect of each of the combined exemplary embodiment and modifications. In the above-described exemplary embodiments, the contents that can be changed in design are emphasized with notations such as “of the present exemplary embodiment” and “in the present exemplary embodiment”, but the design change is allowed even in the contents without such notations. The hatching applied to the cross section of the drawing does not limit a material of a hatched target.

(First Modification)

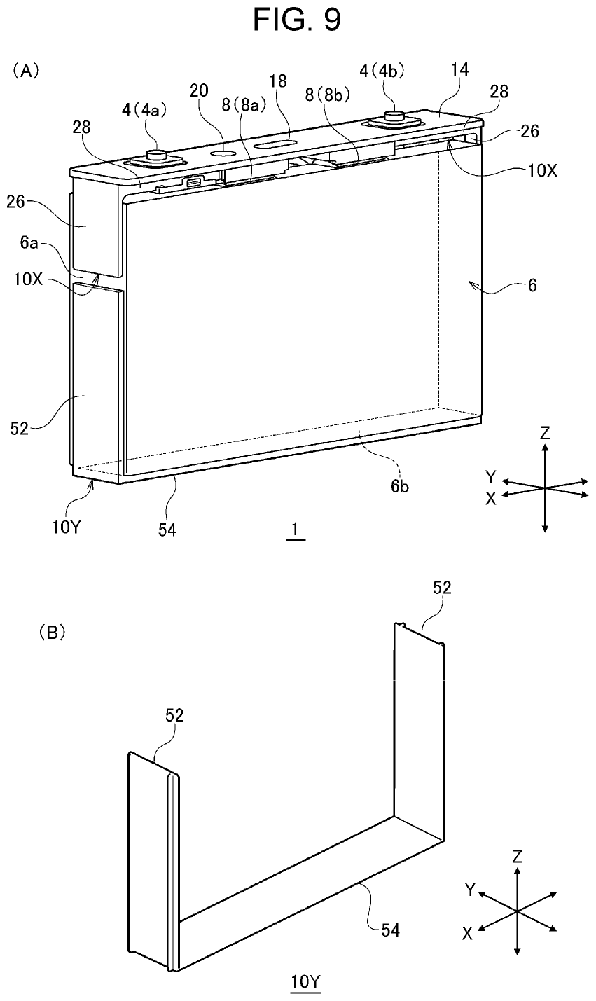

FIG. 9(A) is a perspective view of power storage device 1 according to a first modification. FIG. 9(B) is a perspective view of a second electrode assembly holder. In FIG. 9(A), illustration of outer can 12 is omitted. Power storage device 1 of the first modification includes an electrode assembly holder different from electrode assembly holder 10 in addition to electrode assembly holder 10 included in power storage device 1 according to the first or second exemplary embodiment. In the following description, for convenience, electrode assembly holder 10 of the first or second exemplary embodiment is referred to as first electrode assembly holder 10X, and an electrode assembly holder different from first electrode assembly holder 10X is referred to as second electrode assembly holder 10Y. FIG. 9(A) shows electrode assembly holder 10 of the first exemplary embodiment as first electrode assembly holder 10X.

Electrode assembly 6 has second surface 6b that connects end portions of the pair of first surfaces 6a opposite to the terminal arrangement part. Second surface 6b is a bottom surface of electrode assembly 6. Second electrode assembly holder 10Y includes a pair of third plate parts 52 and fourth plate part 54. The pair of third plate parts 52 extend in third direction Z and have contact with the pair of first surfaces 6a. Specifically, one third plate part 52 has contact with first surface 6a close to positive electrode terminal 4a below first plate part 26 of first electrode assembly holder 10X. Another third plate part 52 has contact with first surface 6a close to negative electrode terminal 4b below first plate part 26 of first electrode assembly holder 10X.

Fourth plate part 54 extends in first direction X, has contact with second surface 6b of electrode assembly 6, and has both end portions connected to the pair of third plate parts 52. Accordingly, second electrode assembly holder 10Y has a substantially U shape as viewed in second direction Y. The displacement of electrode assembly 6 can be further suppressed by attaching second electrode assembly holder 10Y to electrode assembly 6. Accordingly, the reliability of power storage device 1 can be further enhanced. In the power storage device of the present disclosure, second electrode assembly holder 10Y is not indispensable.

(Others)

Electrode assembly 6 is not limited to a stacked electrode assembly in which a plurality of positive electrode plates and a plurality of negative electrode plates are alternately stacked with electrode plate separators interposed therebetween. For example, electrode assembly 6 may be a flat-winding-type electrode assembly in which a band-shaped positive electrode plate and a band-shaped negative electrode plate are wound and compressed in a predetermined direction in a state where the positive electrode plate and the negative electrode plate are stacked with an electrode plate separator interposed therebetween. In addition, the shape of opening 12a of outer can 12 may be a quadrangular shape such as a square, a polygonal shape other than the quadrangular shape, or the like. In addition, the terminal arrangement part may be provided in outer can 12. Output terminals 4 may not be arranged in first direction X.

### REFERENCE MARKS IN THE DRAWINGS

1 power storage device
2 housing
4 output terminals
6 electrode assembly
6a first surface
6b second surface
8 current collecting parts
10 electrode assembly holder
10a, 10b holder unit
10X first electrode assembly holder
10Y second electrode assembly holder
22 current collecting plates
24 current collecting tabs
26 first plate part
28 second plate part
32 connecting part
48 cutout part
52 third plate part
54 fourth plate part

1. A power storage device comprising:
a housing including a terminal arrangement part;
a pair of output terminals provided in the terminal arrangement part;
an electrode assembly housed in the housing;
a pair of current collecting parts that electrically connect the electrode assembly and the pair of output terminals; and
an electrode assembly holder that is provided with an insulating property, has contact with a pair of first surfaces of the electrode assembly facing each other in a first direction in which the pair of current collecting parts are arranged, is fixed to the housing, and sandwiches the electrode assembly in the first direction.

2. The power storage device according to claim 1, wherein the electrode assembly holder includes: a pair of first plate parts that have contact with the pair of first surfaces; and a second plate part that is disposed integrally with each of the first plate parts, is interposed between the terminal arrangement part and the electrode assembly, and is fixed to the terminal arrangement part.

3. The power storage device according to claim 2, wherein
each of the current collecting parts includes a current collecting plate fixed to the terminal arrangement part, and a belt-shaped current collecting tab connecting the electrode assembly and the current collecting plate, and
the second plate part is interposed between the terminal arrangement part and the current collecting plate to electrically insulate the terminal arrangement part and the current collecting plate from each other.

4. The power storage device according to claim 2, wherein a thickness of the second plate part is larger than a thickness of the first plate parts.

5. The power storage device according to claim 4, wherein the second plate part has contact with the terminal arrangement part and the electrode assembly.

6. The power storage device according to claim 2, wherein the electrode assembly holder is provided with a cutout part in a region facing the electrode assembly in a connecting part between the first plate parts and the second plate part.

7. The power storage device according to claim 1, wherein
the electrode assembly holder includes a pair of holder units,
one of the holder units has contact with one of the first surfaces and is fixed to the housing, and
another of the holder units has contact with another of the first surfaces and is fixed to the housing.

8. The power storage device according to claim 1, wherein
the pair of first surfaces extend in a direction intersecting the terminal arrangement part, the electrode assembly includes a second surface that connects end portions of the pair of first surfaces opposite to the terminal arrangement part, and
the power storage device comprises a second electrode assembly holder different from a first electrode assembly holder that is the electrode assembly holder according to claim 1, the second electrode assembly holder including a pair of third plate parts that have contact with the pair of the first surfaces, and a fourth plate part that has contact with the second surface and is connected to the pair of third plate parts.
